(19) United States
(12) Patent Application Publication
(10) Pub. No.: US 2004/0036345 A1
(43) Pub. Date: Feb. 26, 2004

(54) Four-point seat belt having electric motor driven retractor

(75) Inventors: Arnold J. Herberg, Davisburg, MI (US); Uwe M. Class, Schechingen (DE); Joseph J. Zwolinski, Warren, MI (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Vehicle Safety Systems Inc. & TRW Occupant Restraint Systems GmbH & Co. KG

(21) Appl. No.: 10/224,040

(22) Filed: Aug. 20, 2002

(51) Int. Cl. B60R 22/195

(52) U.S. Cl. 297/480; 297/484

(57) ABSTRACT

A vehicle restraint system (30) for helping to restrain a vehicle occupant (18) in a vehicle seat (10) comprises first and second shoulder belts (36 and 38) and first and second lap belts (32 and 34). The first and second shoulder belts (36 and 38) extend over first and second shoulders, respectively, of the vehicle occupant (18). The first lap belt (32) is for extending across a first lap portion of the vehicle occupant (18) and the second lap belt (34) is for extending across a second lap portion of the vehicle occupant (18). A buckle assembly (90) interconnects the first and second shoulder belts (36 and 38) and the first and second lap belts (32 and 34). The vehicle restraint system (30) also includes at least one electric motor driven retractor (50) operatively connected to the first and second lap belts (32 and 34) for, when operated, retracting portions of the first and second lap belts (32 and 34).

### TECHNICAL FIELD

The present invention relates to a vehicle restraint system for helping to protect a vehicle occupant during a crash condition. More particularly, the present invention relates to vehicle restraint system having a four-point seat belt.

### BACKGROUND OF THE INVENTION

U.S. Pat. No. 6,076,894, which is assigned to one of the assignees of the present invention, discloses a seat belt system having two shoulder belts and two lap belts. Each shoulder belt extends from an associated shoulder belt retractor, which is fixed relative to an upper portion of a vehicle seat, downward to a buckle assembly. One lap belt extends upwardly from an anchor on the right side of the vehicle seat and through the buckle assembly. The lap belt then extends downwardly from the buckle assembly to a lap belt retractor. The other lap belt extends upwardly from an anchor on the left side of the vehicle seat and through the buckle assembly. The other lap belt then extends downwardly from the buckle assembly to the lap belt retractor.

The lap belt retractor of the seat belt system includes a rewind spring having a strength that is greater than the combined strength of the shoulder belt retractor rewind springs. The stronger lap belt retractor rewind spring helps to locate the buckle assembly adjacent the waist of an occupant of the seat. The occupant of the seat must manually overcome the combined rewind forces of the lap belt retractor spring and the springs of the shoulder belt retractors in the process of buckling himself or herself into the seat belt system.

### SUMMARY OF THE INVENTION

The present invention relates to a vehicle restraint system for helping to restrain a vehicle occupant in a vehicle seat. The vehicle restraint system comprises first and second shoulder belts. The first shoulder belt is for extending over a first shoulder of the vehicle occupant and the second shoulder belt is for extending over a second shoulder of the vehicle occupant. The vehicle restraint system also comprises first and second lap belts. The first lap belt is for extending across a first lap portion of the vehicle occupant and the second lap belt is for extending across a second lap portion of the vehicle occupant. A buckle assembly is provided for interconnecting the first and second shoulder belts and the first and second lap belts. The vehicle restraint system still further comprises at least one electric motor driven retractor that is operatively connected to the first and second lap belts for, when operated, retracting portions of the first and second lap belts.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a vehicle restraint system constructed in accordance with the present invention;

FIG. 2 is a schematic side view of the vehicle restraint system of FIG. 1;

FIG. 3 is an enlarged sectional view of a portion of the vehicle restraint system of FIG. 1;

FIG. 4 is a schematic illustration of a control system for the vehicle restraint system of FIG. 1;

FIGS. 5A and 5B are flow diagrams of an exemplary control process for the vehicle restraint system of FIG. 1; and

FIG. 6 is a schematic illustration of a vehicle restraint system constructed in accordance with a second embodiment of the present invention.

### DETAILED DESCRIPTION OF THE INVENTION

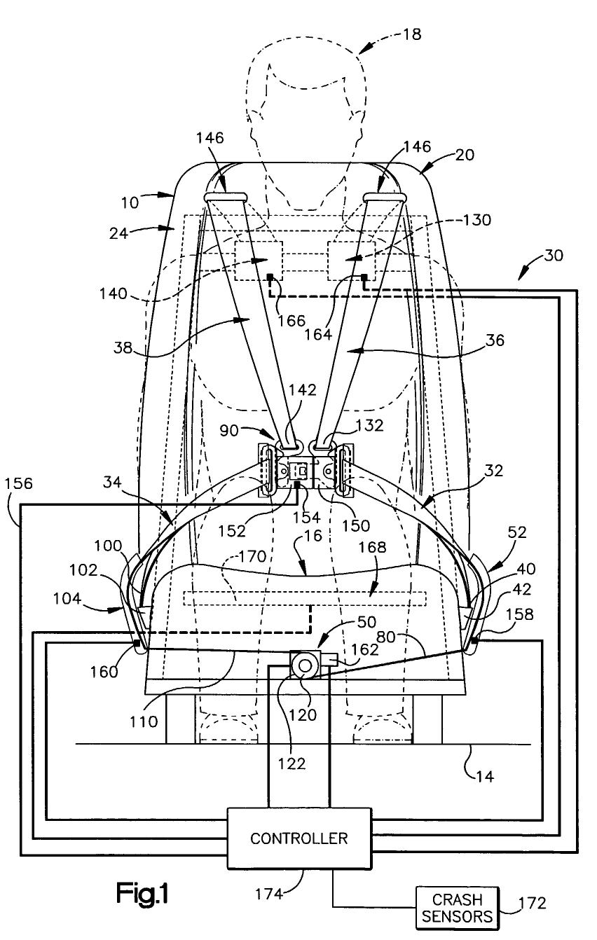

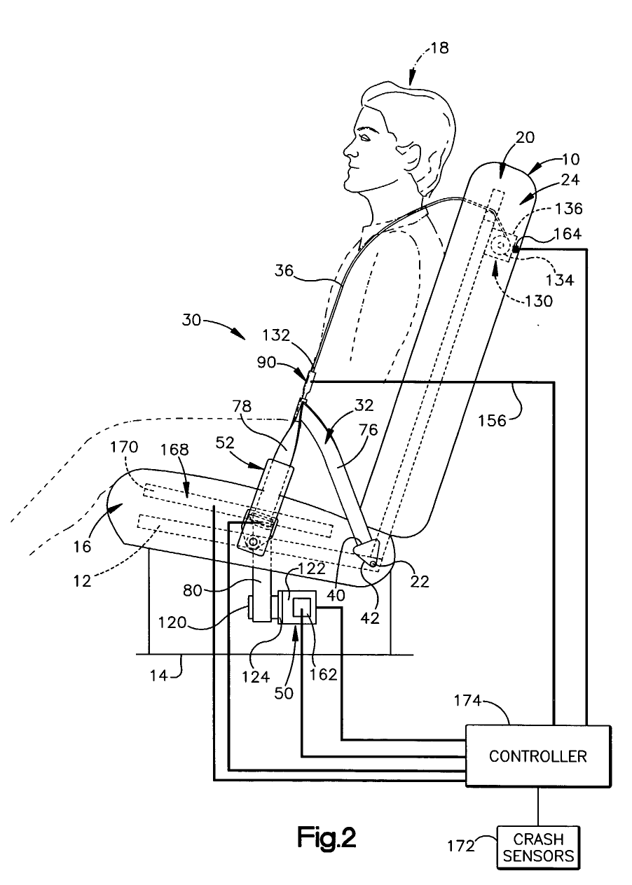

A vehicle seat 10 is shown in FIGS. 1 and 2. The seat 10 includes a frame 12 (FIG. 2) that is secured to the vehicle 14 in a known manner. The seat 10 also includes a cushion portion 16 upon which a vehicle occupant 18 sits and a backrest portion 20 that extends upwardly from the cushion portion. A hinge 22 (FIG. 2) connects the backrest portion 20 of the seat 10 to the cushion portion 16 of the seat. An upper portion 24 of the backrest portion 20 of the seat 10 is located adjacent the shoulders of the seated occupant 18.

FIGS. 1 and 2 also illustrate a vehicle restraint system 30 for helping to restrain the occupant 18 in the seat 10. The vehicle restraint system 30 illustrated in FIGS. 1 and 2 may be referred to as a “four-point seat belt system.” The four-point seat belt system 30 includes lap belts 32 and 34 and shoulder belts 36 and 38. Each lap belt 32 and 34 extends over a portion of the lap of the occupant 18 and each shoulder belt 36 and 38 extends over an associated shoulder of the occupant.

Lap belt 32 has an end 40 that is connected to the frame 12 on the left side of the seat 10. An anchor 42 fixes end 40 to the frame 12. The anchor is located adjacent the hinge 22 of the seat 10 and may be attached to the frame 12 of the seat in any suitable manner. The end 40 of the lap belt 32 is pivotal about the anchor 42 and relative to the seat 10. An opposite end (not shown) of lap belt 32 is connected to a lap belt retractor 50. The lap belt retractor 50 is mounted to the frame 12 of the seat 10 in a location below the cushion portion 16 of the seat.

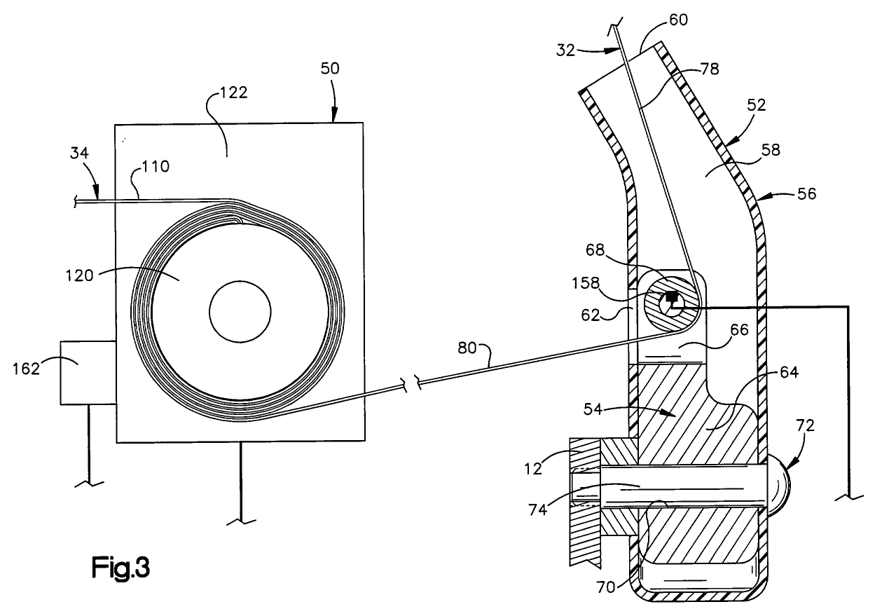

A tubular lap belt guide 52 is attached to the frame 12 on the left side of the seat 10. FIG. 3 illustrates an exemplary embodiment of the lap belt guide 52. The guide 52 includes a D-ring portion 54. The D-ring portion 54 of the guide 52 is located within a cover portion 56 of the guide. A passage 58 extends from an open top 60 of the guide 52 to the D-ring portion 54 of the guide. An opening 62 is provided on an inside wall of the cover portion 56 of the guide 52, adjacent the D-ring portion 54.

The D-ring portion 54 of lap belt guide 52 includes a base 64, an arm 66, and a roller 68. The base 64 includes a bore 70. When the guide 52 is attached to the frame 12 of the seat 10, a shank portion 74 of an anchor 72 extends through the bore 70 of the base 64 of the D-ring portion 54, as shown in FIG. 3. As a result, the D-ring portion 54 of the guide 52 is pivotal relative to the seat 10. The arm 66 of the guide 52 extends upwardly from the base 64 and supports the roller 68.

A first length 76 (FIG. 2) of lap belt 32 extends from end 40 and upward to a buckle assembly 90. A second length 78 (FIG. 2) of lap belt 32 extends downwardly from the buckle assembly 90, into the open top 60 of guide 52, and partially around the roller 68 of the D-ring portion 54 of the guide 52. The first length 76 is oriented at an acute angle relative to the second length 78.

As shown in FIG. 3, the direction of lap belt 32 changes at the roller 68 of the D-ring portion 54 of the guide 52. A third length 80 of lap belt 32 extends from the roller 68 of the D-ring portion 54 of the guide 52, through the opening 62 in the inner wall of the cover portion 56 of the guide 52, and to the lap belt retractor 50.

The sum of the first, second, and third lengths 76, 78, and 80, respectively, of lap belt 32 equals the withdrawn length of lap belt 32. Pulling upwardly on the second length 78 to withdraw lap belt 32 from the lap belt retractor 50 varies the withdrawn length of lap belt 32. Thus, the withdrawn length of lap belt 32 is adjustable.

Lap belt 34 is similar in construction to lap belt 32. Lap belt 34 has an end 100 (FIG. 1) that is connected to the frame 12 on the right side of the seat 10. An anchor 102 fixes end 100 to the frame 12. The anchor 102 is located adjacent the hinge 22 of the seat 10 and may be attached to the frame 12 of the seat in any suitable manner. The end 100 of the lap belt 34 is pivotal about the anchor 102 and relative to the seat 10. An opposite end (not shown) of lap belt 34 is connected to the lap belt retractor 50.

A tubular lap belt guide 104 is attached to the right side of the seat 10. The tubular lap belt guide 104 is similar to the lap belt guide 52 illustrated in FIG. 3 and also includes a D-ring portion (not shown).

A first length of lap belt 34 extends from the anchor 102 at end 100 and upward to a buckle assembly 90. A second length of lap belt 34 extends downwardly from the buckle assembly 90, into the open top of guide 104, and partially around a roller (not shown) of the D-ring portion of the guide 104. The first length is oriented at an acute angle relative to the second length. A third length 110 of lap belt 34 extends from the D-ring portion of the guide 104 to the lap belt retractor 50.

The sum of the first, second, and third lengths of lap belt 34 equals the withdrawn length of lap belt 34. Pulling upwardly on the second length to withdraw lap belt 34 from the lap belt retractor 50 varies the withdrawn length of lap belt 34.

The lap belt retractor 50 illustrated in FIGS. 1 and 2 is a dual payout retractor and includes a single spool 120 for receiving both lap belts 32 and 34. As shown in FIG. 1, lap belt 32 extends from a lower side of the spool 120 and toward guide 52. Lap belt 34 extends from an upper side of the spool 120 and toward guide 104. Thus, rotation of the spool 120 in a clockwise direction, as viewed in FIG. 1, results in the retraction of both lap belts 32 and 34, and rotation of the spool 120 in a counterclockwise direction, as viewed in FIG. 1, results in the withdrawal of both lap belts 32 and 34.

The lap belt retractor 50 includes an electric motor 122. The electric motor 122 is operatively connected to the spool 120 for driving the spool 120 in a retraction direction, clockwise as shown in FIG. 1. A clutch 124 (FIG. 2) is interposed between the electric motor 122 and the spool 120 and, when engaged, operatively connects the electric motor and the spool. The clutch 124 automatically engages when the electric motor 122 is operated to allow the electric motor to drive the spool 120 in the retraction direction. The clutch 124 remains engaged during operation of the electric motor 122 so as to prevent withdrawal of the lap belts 32 and 34 during operation of the electric motor. The clutch 124 automatically disengages, in response to the electric motor 122 discontinuing operation, to allow rotation of the spool 120 in the withdrawal direction permitting manual withdrawal of the lap belts 32 and 34 from the lap belt retractor 50.

A spring (not shown) is connected with the spool 120 to provide resistance to rotation of the spool 120 in the withdrawal direction. Since the spring is used for resistance, the spring force applied by the spring can be relatively small as compared to a typical rewind spring. Alternatively, a typical rewind spring may also be used. The rewind spring would rotate the spool 120 in the retraction direction and provide a larger spring force that would have to be overcome to rotate the spool 120 in the withdrawal direction. When a rewind spring is used, the electric motor 122 is used for rotating the spool 120 in the retraction direction to apply a tension to the lap belts 32 and 34 that is greater than the tension applied by the rewind spring.

Alternatively, the electric motor 122 of the lap belt retractor 50 may be used to drive the spool 120 in both the withdrawal direction and the retraction direction. In such a case, the resistance spring, or alternatively, the rewind spring, may be eliminated from the lap belt retractor 50. A lap belt tension sensor, which is described below, is used to monitor for a withdraw tension in the lap belts 32 and 34. A withdraw tension is a tension in the lap belts 32 and 34 that is indicative of an occupant's attempt to withdraw the lap belts manually. The electric motor 122 is operated to rotate the spool 120 of the lap belt retractor 50 in the withdrawal direction in response to the tension sensor indicating a tension in the lap belts 32 and 34 of at least the withdraw tension. When the tension in the lap belts 32 and 34 drops below the withdraw tension, the electric motor 122 is stopped. When the electric motor 122 is used to drive the spool 120 in both the withdrawal direction and the retraction direction, the electric motor 122 must be a reversible electric motor.

The lap belt retractor 50 also includes a locking mechanism (not shown) for locking the spool 120 and preventing unwinding or withdrawing of the lap belts 32 and 34. The locking mechanism locks the spool 120 in response to the occurrence of any or all of (a) a vehicle deceleration above a predetermined value, (b) an acceleration of the spool 120 in the withdrawal direction above a predetermined value, and (c) a vehicle angular rotation of greater than a predetermined amount.

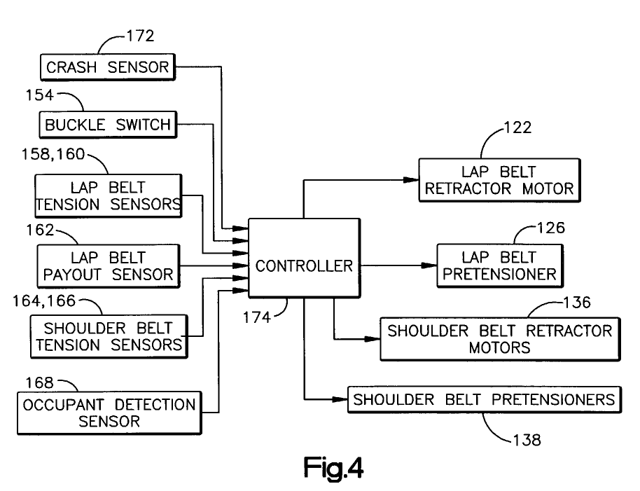

A lap belt pretensioner, shown schematically in FIG. 4 at 126, is operatively connected to lap belts 32 and 34. When actuated, the lap belt pretensioner 126 tensions the lap belts 32 and 34 to help remove slack from the lap belts and position the occupant 18 on the seat 10. Preferably, the lap belt pretensioner 126 forms a part of the lap belt retractor 50 and, when actuated, rotates the spool 120 in the retraction direction to tension both lap belts 32 and 34 simultaneously.

Each of the shoulder belts 36 and 38 of the four-point seat belt system 30 extends outwardly from the upper portion 24 of the backrest portion 20 of the seat 10. Shoulder belt 36 is associated with a left shoulder of the occupant 18, and shoulder belt 38 is associated with the right shoulder of the occupant.

Shoulder belt 36 has a first end (not shown) that is connected with shoulder belt retractor 130 and a second end 132 that is connected to the buckle assembly 90. Shoulder belt retractor 130 is mounted on the frame 12 of the backrest portion 20 of the seat 10. When the occupant 18 is seated in the seat 10, as shown in FIG. 1, shoulder belt 36 extends over the left shoulder of the occupant 18. The withdrawn length of shoulder belt 36 is adjustable.

Shoulder belt retractor 130 includes a spool 134 (FIG. 2). The first end of shoulder belt 36 is secured to the spool 134 of shoulder belt retractor 130 and a portion of shoulder belt 36 is wound around the spool. An electric motor 136 (FIG. 2) is operatively connected to the spool 134 of shoulder belt retractor 130. The electric motor 136 drives the spool 134 in a retraction direction, i.e., clockwise as viewed in FIG. 2. A clutch (not shown) is interposed between the electric motor 136 and the spool 134 and, when engaged, operatively connects the electric motor and the spool. The clutch automatically engages when the electric motor 136 is operated to allow the electric motor to drive the spool 134 in the retraction direction. The clutch remains engaged during operation of the electric motor 136 so as to prevent withdrawal of the shoulder belt 36 during operation of the electric motor. The clutch automatically disengages, in response to the electric motor 136 discontinuing operation, to allow rotation of the spool 134 in the withdrawal direction permitting manual withdrawal of the shoulder belt 36 from the shoulder belt retractor 130. A spring (not shown) is connected with the spool 134 to provide some resistance to rotation of the spool in the withdrawal direction.

Alternatively, the electric motor 136 may be used to drive the spool 134 in both a withdrawal direction and the retraction direction. In such a case, the resistance spring may be eliminated, and a shoulder belt tension sensor is used to monitor for a withdraw tension. As a second alternative, the electric motor 136 in shoulder belt retractor 130 may be replaced with a typical rewind spring. The rewind spring would rotate the spool 134 in the retraction direction and provide a larger spring force that would have to be overcome to rotate the spool 134 in the withdrawal direction.

Shoulder belt retractor 130 also includes a locking mechanism (not shown) for locking the spool 134 and preventing unwinding or withdrawing of the shoulder belt 36. The locking mechanism locks in response to the occurrence of any or all of (a) a vehicle deceleration above a predetermined value, (b) an acceleration of the spool 120 in the withdrawal direction above a predetermined value, and (c) a vehicle angular rotation of greater than a predetermined amount.

Shoulder belt retractor 130 also includes a pretensioner, shown schematically in FIG. 4 at 138. The pretensioner 138, when actuated, causes the spool 134 of shoulder belt retractor 130 to rotate in a retraction direction to tension shoulder belt 36.

Shoulder belt 38 has a first end (not shown) that is connected with shoulder belt retractor 140 (FIG. 1) and a second end 142 that is connected to the buckle assembly 90. Shoulder belt retractor 140 is mounted on the frame 12 of the backrest portion 20 of the seat 10. When an occupant 18 is seated in the seat 10, as shown in FIG. 1, shoulder belt 38 extends over the right shoulder of the occupant 18. The withdrawn length of shoulder belt 38 also is adjustable.

Shoulder belt retractor 140 includes a spool (not shown). The first end of shoulder belt 38 is secured to the spool of shoulder belt retractor 140 and a portion of shoulder belt 38 is wound around the spool. An electric motor (not shown) is operatively connected to the spool of shoulder belt retractor 140. The electric motor drives the spool in a retraction direction. A clutch (not shown), which operates in a similar manner to the clutch in shoulder belt retractor 130, is interposed between the electric motor and the spool and, when engaged, operatively connects the electric motor and the spool. A spring (not shown) is connected with the spool to provide some resistance to rotation of the spool in the withdrawal direction.

Alternatively, the electric motor may be used to drive the spool in both a withdrawal direction and the retraction direction. In such a case, the spring may be eliminated and a shoulder belt tension sensor is used to monitor for a withdraw tension. As a second alternative, the electric motor in shoulder belt retractor 140 may be replaced with a typical rewind spring. The rewind spring would rotate the spool in the retraction direction and provide a larger spring force that would have to be overcome to rotate the spool in the withdrawal direction.

Shoulder belt retractor 140 also includes a locking mechanism (not shown) for locking the spool and preventing unwinding or withdrawing of the shoulder belt 38. The locking mechanism locks the spool in response to the occurrence of any or all of (a) a vehicle deceleration above a predetermined value, (b) an acceleration of the spool 120 in the withdrawal direction above a predetermined value, and (c) a vehicle angular rotation of greater than a predetermined amount.

Shoulder belt retractor 140 also includes a pretensioner, illustrated schematically in FIG. 4 at 138. The pretensioner 138, when actuated, causes the spool of shoulder belt retractor 140 to rotate in a retraction direction to tension shoulder belt 38.

A guide 146 (FIG. 1) is associated with each shoulder belt 36 and 38 for guiding the shoulder belt from the associated shoulder belt retractor 130 and 140, respectively, and out of the upper portion 24 of the backrest portion 20 of the seat 10. An elongated opening to each guide 146 is illustrated in FIG. 1.

The four-point seat belt system 30 also includes a buckle assembly 90, shown in FIG. 1. The buckle assembly 90 includes first and second buckle members 150 and 152, respectively. The first buckle member 150 includes a lap belt connecting portion and a shoulder belt connecting portion, both of which are slotted belt guides. A tongue assembly extends outwardly of the first buckle member 150. Lap belt 32 passes through the lap belt connecting portion of the first buckle member 150. The first buckle member 150 is slidable on lap belt 32 to enable the position of the first buckle member relative to lap belt to be adjusted. End 132 of shoulder belt 36 is fixed to the shoulder belt connecting portion of the first buckle member 150.

The second buckle member 152 also includes a lap belt connecting portion and a shoulder belt connecting portion, both of which are slotted belt guides. A latch mechanism also forms a portion of the second buckle member 152. Lap belt 34 passes through the lap belt connecting portion of the second buckle member 152. The second buckle member 152 is slidable on lap belt 34 to enable the position of the second buckle member 152 relative to lap belt 34 to be adjusted. End 142 of shoulder belt 38 is fixed to the shoulder belt connecting portion of the second buckle member 152.

The latch mechanism of the second buckle member 152 includes a buckle switch 154. When the tongue assembly of the first buckle member 150 is received into and latched by the latch mechanism of the second buckle member 152, the buckle switch 154 outputs an electronic signal indicating the latched condition of the buckle assembly 90. The electronic signal may be transferred through a wire, shown schematically at 156, that is preferably woven into shoulder belt 38 and is operatively connected to the buckle switch 154. Alternatively, the electronic signal may be transferred by wireless communication such as a radio frequency signal.

As shown schematically in FIG. 1, the vehicle restraint system 30 also includes first and second lap belt tension sensors 158 and 160. The first lap belt tension sensor 158 senses tension in lap belt 32 and outputs a signal indicative of the sensed tension. The second lap belt tension 160 sensor senses tension in lap belt 34 and outputs a signal indicative of the sensed tension. In an exemplary embodiment, the first and second tension sensors 158 and 160 are strain gauges, each of which is mounted to the roller of the D-ring portion of its respective lap belt guide 52 or 104. FIG. 3. illustrates a lap belt tension sensor 158 mounted to the roller 68 of the D-ring portion 54 of guide 52. Alternatively, a single lap belt tension sensor may monitor the amperage of the electric motor 122 of the lap belt retractor 50 and output an electrical signal indicative of the amperage. The amperage of the electric motor 122 is related to the tension of the lap shoulder belts 32 and 34 in a known manner.

The vehicle restraint system 30 also includes a lap belt payout sensor 162. In an exemplary embodiment, the lap belt payout sensor 162 includes a magnet attached to the spool 120 of the lap belt retractor 50 and a Hall effect device that is mounted adjacent to the spool for monitoring rotation of the spool. The lap belt payout sensor 162 outputs a signal indicative of an amount of each lap belt 32 and 34 withdrawn from the lap belt retractor 50, i.e., the withdrawn lengths of lap belts 32 and 34. Alternatively, a rotor position sensor of the electric motor 122 may be used as the lap belt payout sensor.

The vehicle restraint system 30 also includes shoulder belt tension sensors 164 and 166 (FIG. 1) for monitoring tension in shoulder belts 36 and 38, respectively. In an exemplary embodiment, each shoulder belt tension sensor 164 and 166 monitors the amperage of the electric motor of a respective shoulder belt retractor 130 and 140 and outputs an electrical signal indicative of the amperage. The amperage of each electric motor is related to the tension of the associated shoulder belt 36 and 38 in a known manner.

The vehicle restraint system 30 also includes an occupant detection sensor 168 for sensing the presence of the occupant 18 in the seat 10. In an exemplary embodiment of the invention, the occupant detection sensor 168 is a weight sensor 170 that monitors the weight of an object positioned on the seat 10. The weight sensor 170 outputs an electrical signal indicative of the sensed weight. Alternative occupant detection sensors 168 may be used. For example, an ultrasonic sensor may be used to detect the presence of the occupant 18 in the seat 10.

The vehicle restraint system 30 also includes one or more crash sensors 172. Each of the crash sensors 172 senses a vehicle condition indicating the occurrence of a crash condition and outputs an electric signal indicative of the crash condition. In an exemplary embodiment of the invention, each of the crash sensors 172 senses vehicle deceleration.

The buckle switch 154 and each sensor 158-172 of the vehicle restraint system are operatively connected to a controller 174. The controller 174 is preferably a microcomputer. The controller 174 receives power from a power source (not shown), such as the vehicle battery. As schematically illustrated in FIG. 4, the controller 174 receives the electrical signals output from the buckle switch 154 and from each of the various sensors 158-172. The controller 174 is also operatively connected to the lap belt retractor electric motor 122, the lap belt pretensioner 126, the electric motors, one shown at 136, of shoulder belt retractors 130 and 140, and the shoulder belt pretensioners 138. The controller 174 processes the electrical signals received from the buckle switch 154 and the sensors 158-172 and, in response to the received electrical signals, controls the operation of the lap belt retractor electric motor 122, the electric motors 136 of the shoulder belt retractors 130 and 140, and the pretensioners 126 and 138.

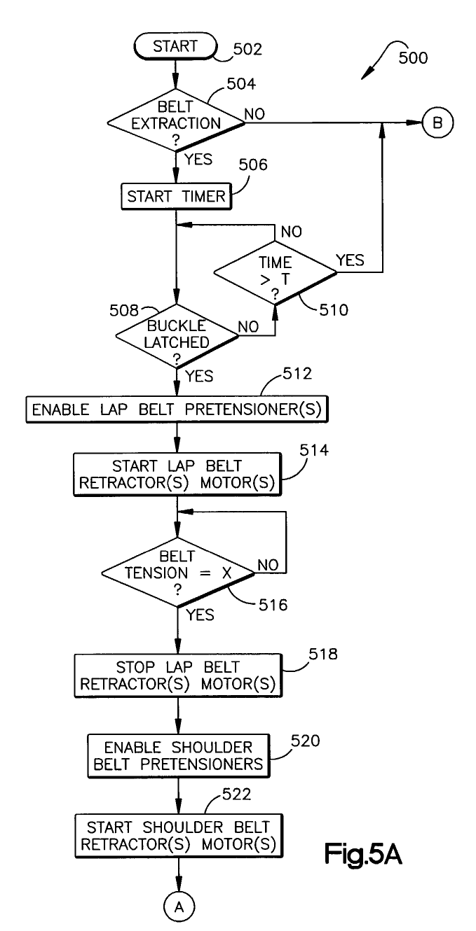

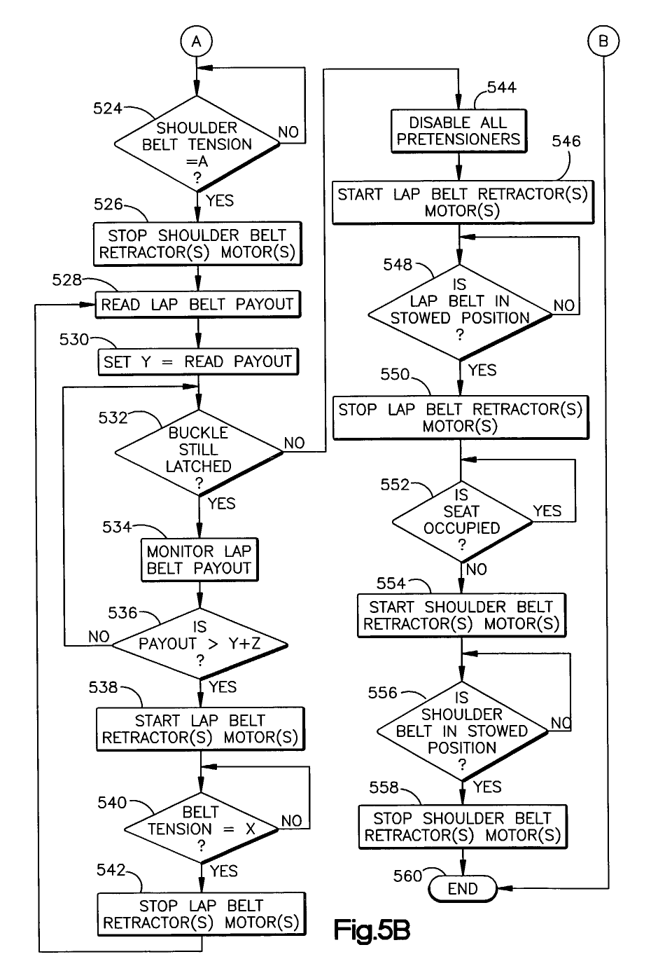

FIGS. 5A and 5B illustrate a flow diagram of a control process 500 of the controller 174 in an exemplary embodiment of the present invention. An object of the present invention is to position the buckle assembly 90 properly relative to the occupant 18 when the first and second buckle members 150 and 152 are interconnected or latched together. The buckle assembly 90 is preferably centered relative to the seat 10. Thus, when the occupant 18 is seated in the position illustrated in FIGS. 1 and 2, the buckle assembly 90 is centered on the occupant's lap, slightly below the waist of the occupant.

In the process 500, the electric motor 122 of the lap belt retractor 50 and the electric motors 136 of shoulder belt retractors 130 and 140 are used only for retracting the respective belts 32-38. Withdrawal of the respective belts 32-38 is done manually by the occupant 18 and must overcome any resistance provided by the resistance springs of the retractors 50, 130, and 140.

The process 500 begins at step 502 in which the controller 174 is initialized, memories are cleared and set to initial values, and flags are set to initial conditions. The process 500 then proceeds to step 504. At step 504, a determination is made as to whether the lap belts 32 and 34 have been extracted or withdrawn from a retracted position. To determine whether the lap belts 32 and 34 have been withdrawn from the retracted position, the controller 174 monitors the lap belt payout sensor 162. The payout or withdrawn length of each lap belt 32 and 34 when in the retracted position is known. Thus, when the lap belt payout sensor 162 indicates lap belt payout of greater than the retracted position payout, it is assumed that the lap belts 32 and 34 have been manually withdrawn from the retracted position. Alternatively, the controller 174 may monitor the lap belt tension sensors 158 and 160 for tensions that are indicative of extraction or withdrawal of the lap belts 32 and 34. If the determination at step 504 is negative, indicating no withdrawal of the lap belts 32 and 34 from the retracted position, the process 500 proceeds to step 560 and the process ends. If the determination at step 504 is affirmative, the process 500 proceeds to step 506 in which a timer (not shown), which is internal to controller 174, is started.

The process 500 then proceeds to step 508. At step 508, a determination is made as to whether the buckle assembly 90 is latched. To determine whether the buckle assembly 90 is latched, the controller 174 monitors the buckle switch 154. If the determination at step 508 is negative, the process 500 proceeds to step 510. At step 510, a determination is made as to whether the timer indicates a time of greater than or equal to a predetermined time, indicated as T in FIG. 5. If the determination at step 510 is negative, the process 500 returns to step 508. If the determination at step 510 is affirmative, the process 500 proceeds to step 560 and the process ends.

If the determination at step 508 is affirmative, the process 500 proceeds to step 512. At step 512, the process 500 enables the lap belt pretensioner 126. Thereafter, if the controller 174 receives a signal from one of the crash sensors 172 that indicates the occurrence of a vehicle crash condition, the lap belt pretensioner 126 may be actuated to tension the lap belts 32 and 34 to attempt to remove slack from the belts. The process 500 then proceeds to step 514. At step 514, the electric motor 122 of the lap belt retractor 50 is started. The electric motor 122 is controlled to rotate the spool 120 of the lap belt retractor 50 in a retraction direction. As a result, the buckle assembly 90 is moved downwardly, as viewed in FIG. 1, to a position at the top of the occupant's lap. Since the lap belt retractor 50 simultaneously retracts lap belts 32 and 34, the buckle assembly 90 is centered relative to the seat 10.

The process 500 then proceeds to step 516. At step 516, a determination is made as to whether the tension in the lap belts 32 and 34 equals a predetermined value, indicated as X in FIG. 5. To make this determination, the controller 174 monitors the lap belt tension sensors 158 and 160. If the determination at step 516 is negative, the process 500 loops back upon itself and continues to monitor the lap belt tension sensors 158 and 160 until an affirmative determination is made. During this step, the electric motor 122 of the lap belt retractor 50 continues to rotate the spool 120 in the retraction direction. If the determination at step 516 is affirmative, the process 500 proceeds to step 518 in which the electric motor 122 of the lap belt retractor 50 is stopped.

The process 500 then proceeds to step 520. At step 520, the shoulder belt pretensioners 138 are enabled. Thereafter, if the controller 174 receives a signal from one of the crash sensors 172 that indicates the occurrence of a vehicle crash condition, the shoulder belt pretensioners 138 may be actuated to tension the shoulder belts 36 and 38.

The process 500 then proceeds to step 522 in which the electric motors 136 of the shoulder belt retractors 130 and 140 are started. The electric motors 136 of the shoulder belt retractors 130 and 140 rotate their associated spools 134 in a retraction direction to shorten the withdrawn lengths of the shoulder belts 36 and 38. The process 500 then proceeds to step 524. At step 524, a determination is made as to whether the tension in the shoulder belts 36 and 38 is equal to a predetermined value, indicated as A. This determination is made separately for each shoulder belt 36 and 38. If the determination at step 524 is negative, the process 500 loops back upon itself and continues to monitor the shoulder belt tension sensors 164 and 166 until an affirmative determination is made. During this step, the electric motors 136 of the shoulder belt retractors 130 and 140 continue to rotate their associated spools 130 in the retraction direction. If the determination at step 524 is affirmative, the process 500 proceeds to step 526 in which the electric motors 136 of the shoulder belt retractors 130 and 140 are stopped.

The process 500 then proceeds to step 528 in which the lap belt payout sensor 162 is monitored to determine the payout or withdrawn lengths of lap belts 32 and 34. The process 500 then proceeds to step 530 in which an initial value for the lap belt payout, indicated as Y in FIG. 5, is set to the payout value determined in step 528. The initial value Y of the lap belt payout indicates the payout of the lap belt 32 or 34 when the buckle assembly 90 is buckled and the lap belts are tensioned to the predetermined value X.

The process 500 then proceeds to step 532. At step 532, a determination is made as to whether the buckle assembly 90 is still latched. If the determination at step 532 is affirmative, the process 500 proceeds to step 534. At step 534, the lap belt payout is again monitored. The process 500 then proceeds to step 536 in which a determination is made as to whether the lap belt payout from step 534 is greater than the sum of the initial lap belt payout Y and a predetermined additional amount, indicated by Z. If the determination at step 536 is negative, the process 500 returns to step 532. If the determination at step 536 is affirmative, the process 500 proceeds to step 538. An affirmative determination at step 536 indicates that the vehicle occupant 18 has shifted or moved in the seat 10 causing additional payout of lap belts 32 or 34.

At step 538, the electric motor 122 of the lap belt retractor 50 is started. The electric motor 122 is controlled to rotate the spool 120 of the lap belt retractor 50 in a retraction direction to simultaneously retract lap belts 32 and 34. The process 500 then proceeds to step 540. At step 540, a determination is made as to whether the tension in the lap belts 32 and 34 equals the predetermined value, indicated as X in FIG. 5. If the determination at step 540 is negative, the process 500 loops back upon itself and continues to monitor the lap belt tension sensors 158 and 160 until an affirmative determination is made. During this step, the electric motor 122 of the lap belt retractor 50 continues to rotate the spool 120 in the retraction direction. If the determination at step 540 is affirmative, the process 500 proceeds to step 542 in which the electric motor 122 of the lap belt retractor 50 is stopped. From step 542, the process 500 returns to step 528.

Returning to step 532, if the determination is negative, the process 500 proceeds to step 544. At step 544, the lap belt pretensioner 126 and the shoulder belt pretensioners 138 are disabled. The process 500 then proceeds to step 546. At step 546, the electric motor 122 of the lap belt retractor 50 is started so that the electric motor drives the spool 120 of the lap belt retractor in a retraction direction. As a result, the lap belts 32 and 34 are wound onto the spool 120 of the lap belt retractor 50 and the first and second buckle members 150 and 152 of the buckle assembly 90 move toward the guides 52 and 104 on their respective sides of the seat 10.

The process 500 then proceeds to step 548. At step 548, a determination is made as to whether the lap belts 32 and 34 are in the retracted or stowed position. The lap belts 32 and 34 are in a retracted position when the first buckle member 150 contacts guide 52 and when the second buckle member 152 contacts guide 104. To determine whether the lap belts 32 and 34 are in the retracted position, the controller 174 monitors the lap belt payout sensor 162. If the determination at step 548 is negative, the process 500 loops back upon itself and the lap belt payout sensor 162 is monitored until the lap belts 32 and 34 reach the retracted position. If the determination at step 548 is affirmative, the process 500 proceeds to step 550 in which the electric motor 122 of the lap belt retractor 120 is stopped.

The process 500 then proceeds to step 552 in which a determination is made as to whether the seat 10 is occupied. To determine if the seat 10 is occupied, the occupant detection sensor 168 is monitored. If the determination at step 552 is affirmative, the process 500 loops back upon itself until the determination at step 552 is negative. Step 552 provides an occupant of seat 10 with time to remove the shoulder belts 36 and 38 prior to commencing withdrawal of the shoulder belts. If the determination at step 552 is negative, the process 500 proceeds to step 554.

The electric motors 136 of the shoulder belt retractors 130 and 140 are started at step 554. The electric motors 136 of the shoulder belt retractors 130 and 140 rotate their associated spools 134 in a retraction direction to retract the shoulder belts 36 and 38. The process 500 then proceeds to step 556. At step 556, a determination is made as to whether the shoulder belts 36 and 38 are in a retracted or stowed position. This determination is made separately for each shoulder belt 36 and 38. If the determination at step 556 is negative, the process 500 loops back upon itself until an affirmative determination is made with respect to each shoulder belt 36 and 38. If the determination at step 556 is affirmative, the process 500 proceeds to step 558 in which the electric motor 136 of respective shoulder belt retractor 130 and 140 is stopped. When the electric motors 136 of both shoulder belt retractors 130 and 140 are stopped, the process 500 then proceeds to step 560 in which the process ends.

As is indicated in the above-described process 500, the lap belts 32 and 34 of the vehicle restraint system 30 are tensioned prior to the shoulder belts 36 and 38. By first tensioning the lap belts 32 and 34, the buckle assembly 90 is positioned at the top of the occupant's lap.

In the event of a vehicle crash condition, the crash sensor 172 outputs a signal that is indicative of the crash condition to the controller 174. The controller 174 processes the crash sensor signal to determine if actuation of the pretensioners 126 and 138 of the vehicle restraint system 30 is desired. If actuation of the pretensioners 126 and 138 is desired, the controller 174 first actuates the lap belt pretensioner 126 and then, after a short delay, actuates the shoulder belt pretensioners 138. By first actuating the lap belt pretensioner 126 to tension lap belts 32 and 34, the position of the buckle assembly 90 on top of the occupant's lap is maintained.

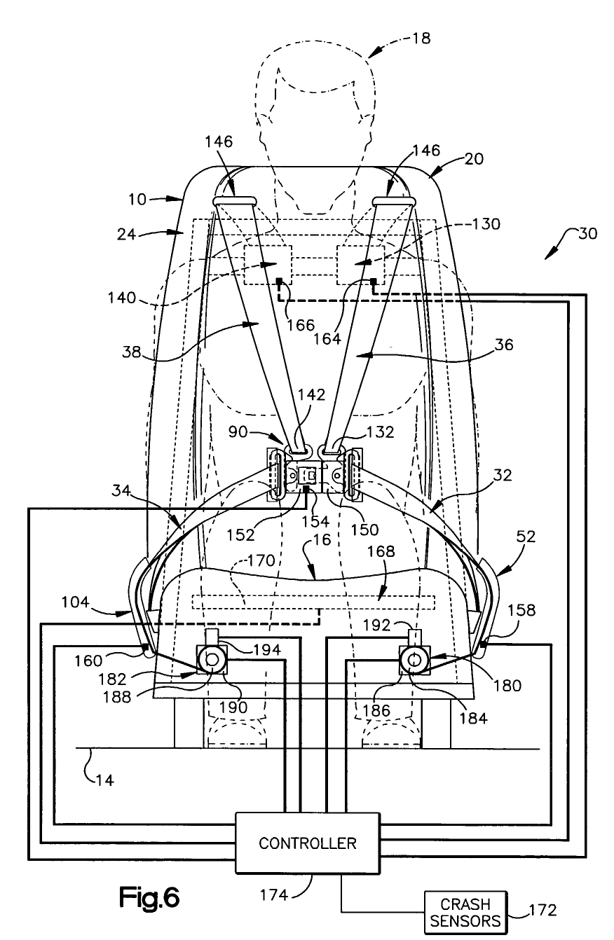

FIG. 6 illustrates a vehicle restraint system 30 constructed in accordance with a second embodiment of the present invention. Structures in FIG. 6 that are similar to or identical to structures of FIG. 1 are indicated using the same reference number.

FIG. 6 illustrates two lap belt retractors 180 and 182. Lap belt retractor 180 is associated with lap belt 32. Lap belt retractor 182 is associated with lap belt 34.

Lap belt retractor 180 includes a spool 184. An end of lap belt 32 is secured to the spool 184 and a portion of lap belt 32 is wound around the spool. Lap belt retractor 180 also includes an electric motor 186. The electric motor 186 is operatively connected to the spool 184 for driving the spool in a retraction direction, clockwise as viewed in FIG. 6. A clutch (not shown) is interposed between the electric motor 186 and the spool 184 and, when engaged, operatively connects the electric motor and the spool. The clutch automatically engages when the electric motor 186 is operated to allow the electric motor to drive the spool 184 in the retraction direction. The clutch remains engaged during operation of the electric motor 186 so as to prevent withdrawal of the lap belt 32 during operation of the electric motor. The clutch automatically disengages, in response to the electric motor 186 discontinuing operation, to allow rotation of the spool 184 in the withdrawal direction permitting manual withdrawal of the lap belt 32 from the lap belt retractor 180. A spring (not shown) is connected with the spool to provide resistance to rotation of the spool 184 in the withdrawal direction.

Alternatively, the electric motor 186 may be used to drive the spool 184 in both the withdrawal direction and the retraction direction. The lap belt tension sensor 158 may be used to monitor for a withdraw tension in lap belt 32. A withdraw tension is a tension in lap belt 32 that is indicative of an occupant's attempt to withdraw the lap belt manually. The electric motor 186 may be operated in the withdrawal direction in response to the tension sensor 158 indicating a tension in lap belt 32 of at least the withdraw tension. When the electric motor 186 is used to drive the spool 184 in both the withdrawal direction and the retraction direction, the electric motor must be a reversible electric motor.

The lap belt retractor 180 also includes a locking mechanism (not shown) for locking the spool 184 and preventing unwinding or withdrawing of lap belt 32. The locking mechanism locks the spool 184 in response to the occurrence of any or all of (a) a vehicle deceleration above a predetermined value, (b) an acceleration of the spool 120 in the withdrawal direction above a predetermined value, and (c) a vehicle angular rotation of greater than a predetermined amount.

A lap belt pretensioner (not shown) is operatively connected to lap belt 32. When actuated, the lap belt pretensioner tensions lap belt 32 to help remove slack from the lap belt and position the occupant 18 on the seat 10.

Lap belt retractor 182 includes a spool 188. An end of lap belt 34 is secured to the spool 188 and a portion of lap belt 34 is wound around the spool. Lap belt retractor 182 also includes an electric motor 190. The electric motor 190 is operatively connected to the spool 188 for driving the spool in a retraction direction, counterclockwise as viewed in FIG. 6. A clutch (not shown), which is similar to the clutch of lap belt retractor 180, is interposed between the electric motor 190 and the spool 188 and, when engaged, operatively connects the electric motor and the spool. A spring (not shown) is connected with the spool to provide resistance to rotation of the spool in the withdrawal direction.

Alternatively, the electric motor 190 may be used to drive the spool 188 in both the withdrawal direction and the retraction direction. The electric motor 190 may be actuated in the withdrawal direction in response to the tension sensor 160 indicating a tension in lap belt 34 of at least the withdraw tension. When the electric motor 190 is used to drive the spool 188 in both the withdrawal direction and the retraction direction, the electric motor 190 must be a reversible electric motor.

The lap belt retractor 182 also includes a locking mechanism (not shown) for locking the spool 188 and preventing unwinding or withdrawing of the lap belt 34. The locking mechanism locks the spool 188 in response to the occurrence of any or all of (a) a vehicle deceleration above a predetermined value, (b) an acceleration of the spool 120 in the withdrawal direction above a predetermined value, and (c) a vehicle angular rotation of greater than a predetermined amount.

A lap belt pretensioner (not shown) is operatively connected to lap belt 34. When actuated, the lap belt pretensioner tensions lap belt 34 to help remove slack from the lap belt and position the occupant 18 on the seat 10.

Each lap belt retractor 180 and 182 includes a lap belt payout sensor 192 and 194. Lap belt payout sensor 192 monitors the payout of lap belt 32 and outputs a signal indicative of the payout to the controller 174. Lap belt payout sensor 194 monitors the payout of lap belt 34 and outputs a signal indicative of the payout to the controller 174.

The controller 174 is operatively connected to the electric motor 186 of lap belt retractor 180 and the electric motor 190 of lap belt retractor 182. In response to the signals from lap belt payout sensors 192 and 194, the controller 174 controls operation of the electric motors. The controller 174 controls the electric motors 186 and 190 so that an equal amount of lap belt 32 and 34 is withdrawn or paid-out from each lap belt retractor 180 and 182. By controlling the electric motors 186 and 190 to payout equal amounts, the controller 174 centers the buckle assembly 90 relative to the seat 10.

In the event of a crash condition where actuation of the pretensioners is desired, the controller 174 simultaneously actuates the lap belt pretensioners so that during tensioning of lap belts 32 and 34, the buckle assembly 90 is maintained in a centered position relative to the seat 10. Following a short time delay after actuation of the lap belt pretensioners, the controller 174 actuates the shoulder belt pretensioners 138.

From the above description of the invention, those skilled in the art will perceive improvements, changes and modifications. For example, the electric motors of the retractors may be operated for tensioning the various belts of the vehicle restraint system in response to an indication of an impending crash condition and for increasing the belt tension in response to a subsequent crash event. Such improvements, changes and modifications within the skill of the art are intended to be covered by the appended claims.

Having described the invention, we claim the following:

1. A vehicle restraint system for helping to restrain a vehicle occupant in a vehicle seat, the vehicle restraint system comprising:
first and second shoulder belts, the first shoulder belt for extending over a first shoulder of the vehicle occupant and the second shoulder belt for extending over a second shoulder of the vehicle occupant;
first and second lap belts, the first lap belt for extending across a first lap portion of the vehicle occupant and the second lap belt for extending across a second lap portion of the vehicle occupant;
a buckle assembly for interconnecting the first and second shoulder belts and the first and second lap belts; and
at least one electric motor driven retractor operatively connected to the first and second lap belts for, when operated, retracting portions of the first and second lap belts.

2. The vehicle restraint system as in claim 1 wherein the at least one electric motor driven retractor includes a spool, a portion of the first lap belt being wound about the spool and a portion of the second lap belt being wound about the spool.

3. The vehicle restraint system as in claim 2 wherein the at least one electric motor driven retractor further includes a clutch, the clutch being interposed between the spool and an electric motor of the at least one electric motor driven retractor, the clutch, when engaged, operatively connecting the spool and the electric motor.

4. The vehicle restraint system as in claim 3 wherein the clutch automatically engages in response to operation of the electric motor of the at least one electric motor driven retractor.

5. The vehicle restraint system as in claim 4 wherein the clutch automatically disengages in response to discontinuation of operation of the electric motor.

6. The vehicle restraint system as in claim 2 wherein the at least one electric motor driven retractor includes a reversible electric motor, the reversible electric motor being operable to rotate the spool in a retraction direction for retracting portions of the first and second lap belts and further being operable to rotate the spool in a withdrawal direction for paying out portions of the first and second lap belts.

7. The vehicle restraint system as in claim 6 further including a lap belt tension sensor for monitoring tension in one of the first and second lap belts, the reversible electric motor being operable to rotate the spool in the withdrawal direction in response to the lap belt tension sensor sensing a tension of at least a predetermined value.

8. The vehicle restraint system as in claim 1 further including a buckle switch for monitoring the buckle assembly for a latched condition, the at least one electric motor driven retractor being operable to retract portions of the first and second lap belts in response to the buckle switch indicating the latched condition of the buckle assembly.

9. The vehicle restraint system as in claim 8 further including a lap belt tension sensor for monitoring lap belt tension in one of the first and second lap belts, the at least one electric motor driven retractor being operable to retract portions of the first and second lap belts until the lap belt tension sensor senses a predetermined lap belt tension.

10. The vehicle restraint system as in claim 1 wherein the at least one electric motor driven retractor includes a first electric motor driven retractor that is operatively connected to the first lap belt and a second electric motor driven retractor that is operatively connected to the second lap belt.

11. The vehicle restraint system as in claim 10 further including a controller for controlling the first and second electric motor driven retractors so that a withdrawn length of the first lap belt equals a withdrawn length of the second lap belt.

12. The vehicle restraint system as in claim 1 further including second and third electric motor driven retractors, the second electric motor driven retractor being operatively connected to the first shoulder belt and being operable to retract a portion of the first shoulder belt, the third electric motor driven retractor being operatively connected to the second shoulder belt and being operable to retract a portion of the second shoulder belt.

13. The vehicle restraint system as in claim 12 further including a controller, the controller being operatively connected to and controlling operation of the at least one electric motor driven retractor and the second and third electric motor driven retractors, the controller operating the at least one electric motor driven retractor to retract portions of the first and second lap belts prior to operating the second and third electric motor driven retractors to retract portions of the first and second shoulder belts.
